(19) United States
(12) Patent Application Publication
(10) Pub. No.: US 2016/0291372 A1
(43) Pub. Date: Oct. 6, 2016

(54) LIQUID CRYSTAL DISPLAY AND METHOD OF MANUFACTURING THE SAME

(71) Applicant: Samsung Display Co., Ltd., Yongin-City (KR)

(72) Inventors: Ho Yun BYUN, Osan-si (KR); Dong Woo KIM, Seoul (KR)

(21) Appl. No.: 14/809,547

(22) Filed: Jul. 27, 2015

(30) Foreign Application Priority Data
Mar. 31, 2015 (KR) 10-2015-0045217

(51) Int. Cl. G02F 1/13363; G02F 1/1368; G02F 1/1362; G02F 1/1333; G02F 1/1335

(52) U.S. Cl. CPC G02F 1/13363; G02F 1/133377; G02F 1/133528; G02F 1/133345; G02F 1/136286; G02F 1/1368

(57) ABSTRACT

A liquid crystal, display includes: a substrate; a thin film transistor positioned on the substrate; a pixel electrode positioned on the thin film transistor; a roof layer facing the pixel electrode; a liquid crystal layer positioned between the pixel electrode and the roof layer including a plurality of micro cavities filled with a liquid crystal material, a capping layer positioned on the roof layer and having a thickness direction phase difference Rth of 120 nm or more to 140 nm or less; and an upper polarizer positioned on the capping layer and a lower polarizer positioned below the substrate.

### CROSS-REFERENCE TO RELATED APPLICATION

This application claims priority to and the benefit of Korean Patent Application No. 10-2015-0045217 filed in the Korean Intellectual Property Office tm Mar. 31, 2015, which is incorporated herein by reference in its entirety.

### BACKGROUND

(a) Field

The present disclosure relates to a liquid crystal display and a method of manufacturing the same.

(b) Description of the Related Art

A liquid crystal display is one of flat panel displays that are currently used widely. The liquid crystal display includes two display panels on which electric held generating electrodes such as pixel electrodes, common electrodes, and the like, are formed, and a liquid crystal layer interposed between the two display panels.

A voltage is applied to the electric field generating electrodes to generate an electric field in the liquid crystal layer, thereby determining alignment of liquid crystal molecules of the liquid crystal layer and controlling polarization of incident light to display an image.

One type of liquid crystal displays has cavities formed in a pixel unit and filled with liquid crystal molecules. This type of liquid crystal display has a sacrificial layer formed with an organic material and a support member formed on the sacrificial layer. The sacrificial layer is removed, and an empty space that is formed by removing the sacrificial layer is filled with liquid crystal through an inlet instead of forming an upper plate above a lower plate.

After the liquid crystal molecules are infected, the inlet may be capped with a capping layer made of a coating material and a polarizer may be attached to an upper portion of the capping layer. However, when the polarizer is attached to the upper portion of the capping layer, the liquid crystal display becomes thicker and larger, thus increasing the manufacturing cost of the liquid crystal display.

The above information disclosed in the Background section is only for enhancement of understanding of the background of the present disclosure, and therefore it may contain information that does not form the prior art that is already known to a person of ordinary skill in the art.

### SUMMARY

The present disclosure provides a liquid crystal display and a method of manufacturing the same having advantages of decreasing the overall thickness of the liquid crystal display and reducing a manufacturing cost of the liquid crystal display by adjusting a thickness direction phase difference Rth of a capping layer and adjusting a thickness of an upper polarizer.

An exemplary embodiment of the present disclosure provides a liquid crystal display including: a substrate; a thin film, translator positioned on the substrate; a pixel electrode positioned on the thin film transistor; a roof layer facing the pixel electrode; a liquid crystal layer positioned between the pixel electrode and the roof layer and including a plurality of micro cavities filled with a liquid crystal material, a capping layer positioned on the roof layer and having a thickness direction phase difference Rth of 120nm or more to 140 nm or less; and an upper polarizer positioned on the capping layer and a lower polarizer positioned below the substrate.

The capping layer may include a material having a thickness direction phase difference Rth changed depending on an ultraviolet (UV) curing condition.

The capping layer may include at least one of an organic insulating material including parylen, silicone, and an ultraviolet (UV) curable sheet.

The upper polarizer may include a polyvinyl alcohol (PVA) layer.

The upper polarizer may exclude an. Rth compensation film.

A thickness direction phase difference Rth of the Rth compensation film may be 120 nm or more to 140 nm or less.

The lower polarizer may include a polyvinyl alcohol (PVA) layer and an Rth compensation film positioned below the substrate.

A thickness direction phase difference Rth of the Rth compensation film may be 120 nm or more to 140 nm or less.

The liquid crystal display may further include a common electrode and a lower insulating layer positioned between each of the plurality of micro cavities and the roof layer, wherein the lower insulating layer is positioned on the common electrode.

The plurality or micro cavities may include a plurality of regions corresponding to pixel areas, trenches may be positioned between plurality of regions and the capping layer may cover the trenches.

The trenches may be extended in a direction that is in parallel with gate lines connected to the thin film transistor.

The thin film transistor may be connected to data lines, and partition wall parts may be formed between the plurality of micro cavities in a direction in which the data lines are extended.

Another exemplary embodiment of the present disclosure provides a method of manufacturing a liquid crystal display including; forming a thin film transistor on a substrate; forming a pixel electrode that is connected to one terminal of the thin film transistor; forming a sacrificial layer on the pixel electrode; forming a roof layer on the sacrificial layer; forming a plurality of micro cavities; forming inlets by removing the sacrificial layer; injecting a liquid crystal material into the plurality of micro cavities; forming a capping layer on the root layer, the capping layer covering the inlets and having a thickness direction phase difference Rth of 120 nm or more to 140 nm or less by UV caring; and forming an upper polarizer on the capping layer and forming a lower polarizer below live substrate.

The capping layer may include a material having a thickness direction phase difference Rth changed depending on an ultraviolet (UV) curing condition.

The capping layer may include at least one of an organic insulating material including parylen, silicone, and an ultraviolet (UV) curable sheet.

The upper polarizer may exclude an Rth compensation film.

The lower polarizer may be positioned below the substrate.

The lower polarizer may include a polyvinyl alcohol (PVA) layer and an Rth compensation film positioned below the substrate.

Other features and advantages of the present disclosure, in addition to the technical object of the present disclosure described above, will be described below or will be clearly understood by those skilled in the art to which the present disclosure pertains from the following description.

An exemplary embodiment of the present disclosure as described above has the following effects. The Rth of the capping layer is adjusted, and the upper polarizer does not include the Rth compensation film, thereby making it possible to decrease an entire thickness of the liquid crystal display and a manufacturing cost of the liquid crystal display.

In addition, other features and advantages of the present disclosure may be newly recognized through exemplary embodiments of the present disclosure.

### BRIEF DESCRIPTION OF THE DRAWINGS

FIG. 1 is a plan view showing a liquid crystal display according to an exemplary embodiment of the present disclosure.

FIG. 2 is a cross-sectional, view taken along line II-II of FIG. 1.

FIG. 3 is a cross-sectional view taken along line III-III of FIG. 1.

FIG. 4 is a view showing a change in Rth depending on an exposure condition of a capping material.

FIGS. 5 to 17 are cross-sectional views showing a method of manufacturing a liquid, crystal display according to an exemplary embodiment of the present disclosure.

### DETAILED DESCRIPTION OF THE EMBODIMENTS

Exemplary embodiments of the present disclosure will he described in detail wife reference to the accompanying drawings. However, the present disclosure is not limited to exemplary embodiments described therein, but may also he embodied in other forms. On the contrary, exemplary embodiments introduced herein are provided to make disclosed contents thorough and complete and sufficiently transfer the spirit of the present disclosure to those skilled in the art.

In the accompanying drawings, thickness of layers and regions may be exaggerated for clarity and illustrative purposes, thus may not be scaled. In addition, it will be understood that when a layer is referred to as being “on” another layer or substrate, the layer can be directly formed on another layer or substrate or the other layer may also be interposed therebetween. Like reference numerals designate like elements throughout the specification.

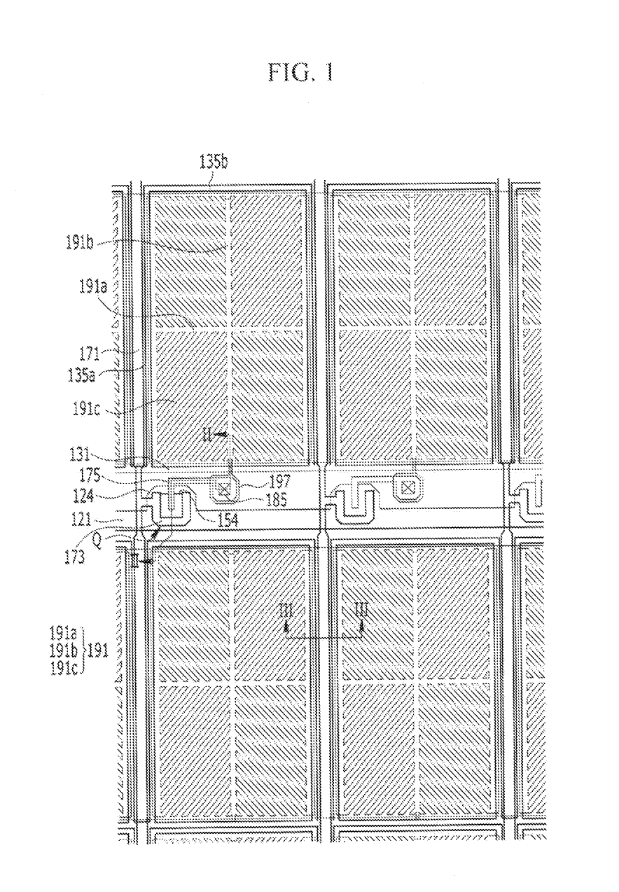

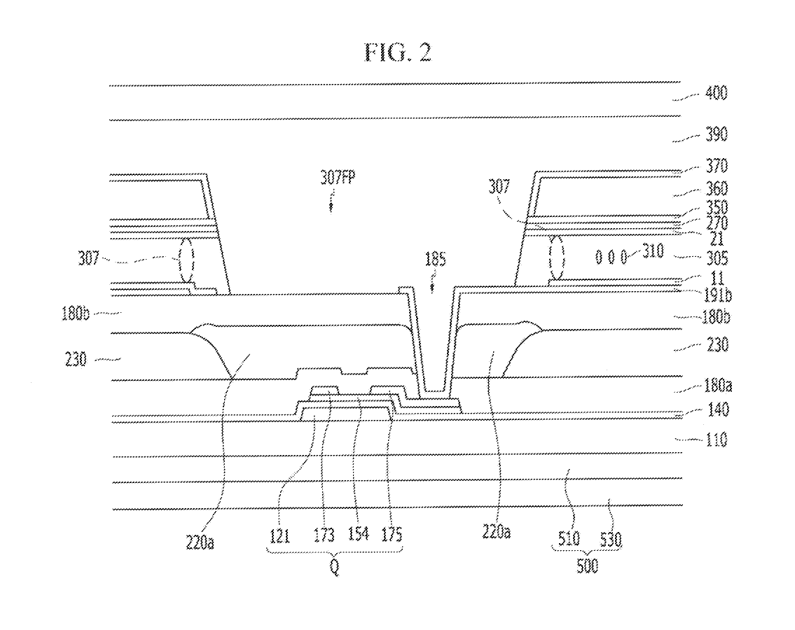

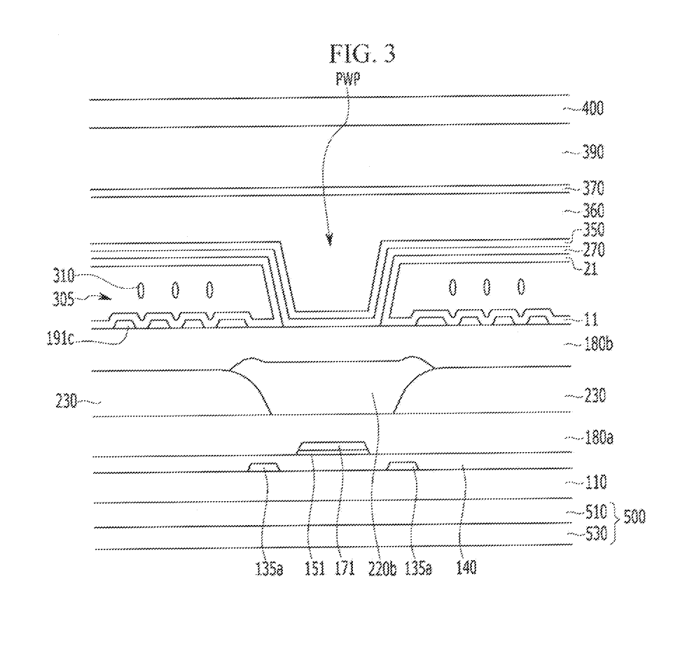

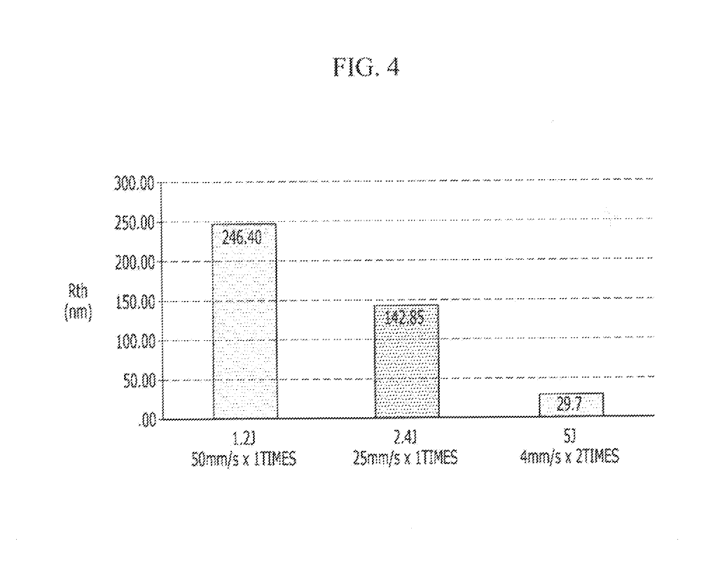

FIG. 1 is a plan view showing a liquid crystal display according to art exemplary embodiment of the present disclosure. FIG. 2 is a cross-sectional view taken along line II-II of FIG. 1. FIG. 3 is a cross-sectional view taken along line III-III of FIG. 1. FIG. 4 is a view showing a change in a thickness direction phase difference Rth depending on an exposure condition of a capping material.

Referring to FIGS. 1 to 3, gate lines 121 and sustain electrode lines 131 are formed on a substrate 110 that is made of a material such as a transparent glass and plastic. The gate lines 121 include gate electrodes 124. The sustain electrode lines 131 are mainly extended in a horizontal direction and transfer a predetermined voltage such as a common voltage Vcom. Each of the sustain electrode lines 131 includes a pair of vertical parts 135a extended substantially vertically to the gate lines 121 and a horizontal part 133b that connects ends of the pair of vertical parts 135a to each other. The vertical parts 135a and the horizontal parts 125b of the sustain electrode lines enclose a pixel electrode 191.

A gate insulating layer 140 is formed on the gate lines 121 and the sustain electrode lines 131. A first semiconductor layer 151 positioned below data lines 171 and a second semiconductor layer 154 positioned below source/drain electrodes and in a channel, portion, of a thin, film transistor Q are formed on the gate insulating layer 140.

A plurality of ohmic contact members (not shown) may be formed on the first and second semiconductor layers 151 and 154 and between the data lines 171 and the source/drain electrodes. The ohmic contact may be made of a material, such as n+ hydrogenated amorphous silicon doped with silicide or n-type impurity at high concentration.

Data conductors including a source electrode 173, the data line 171 connected to the source electrode 173, and a drain electrode 175 are formed on the first and second semiconductor layers 151 and 154 and the gate insulating layer 140.

The gate electrode 124, the source electrode 173, and the drain electrode 175 form the thin film transistor Q together with the second semiconductor layer 154, and a channel of the thin film transistor is formed in a portion of the second semiconductor layer 154 between the source electrode 173 and the drain electrode 175.

A first interlayer insulating layer 180a is formed on the data conductors and the exposed portion of tire second semiconductor layer 154. The first interlayer insulating layer 180a may include an inorganic insulator or an organic insulator such as a silicon nitride (SiNx), a silicon oxide (SiOx), or the like.

Color filters 230 and light blocking members 220 are formed on the first interlayer insulating layer 180a. The light blocking members 220 are configured in a lattice structure and are made of a material that does not transmit light therethrough. The light blocking members 220 have openings corresponding to regions in which an image is displayed; and the color filters 230 are formed in the openings of the light blocking members 220. The light blocking members 220 include a horizontal light blocking member 220a formed in a direction that is in parallel with the gate line 121 and a vertical light blocking member 220b formed in a direction that is in parallel with the data line 271.

The color filters 230 may display one of primary colors such as a red, a green, and a blue color. However, the color filter 230 is not limited to displaying these primary colors, but may also display one of other primary colors such as a cyan, a magenta, a yellow, and a white color. The color filters 230 may be made of materials displaying different colors for each of adjacent pixels.

A second interlayer insulating layer 180b covering the color filters 230 and the light blocking members 220 is formed on the color filters 230 and the light blocking members 220. The second interlayer insulating layer 180b may include an inorganic insulator or an organic insulate such as a silicon nitride (SiNx), a silicon oxide (SiOx), or tire like. A step may be generated due to a thickness difference between the color filter 230 and the light blocking member 220. In this case, the second interlayer insulating layer 180b may include the organic insulator enabling to decrease or remove the step.

Contact holes 185 exposing the drain electrode 175 are formed in the color filters 230, the light blocking members 220, and the first and second interlayer insulating layers 180a and 180b. The pixel electrodes 191 are formed on the second interlayer insulating layer 180b. The pixel electrode 191 may be made of a transparent conductive material such as an ITO, an IZO, or five like. The pixel electrode 192 generally has a rectangular shape, and includes a cross-shaped stem part including a horizontal stem part 191a and a vertical stem part 191b that intersects with the horizontal stem part 192a. In addition, the pixel electrode 191 is divided into four sub-regions by the horizontal stem part 192a and the vertical stem part 191b, and each of the sub-regions includes a plurality of fine branch parts 191c. In addition, the pixel electrode 191 may further include an outer side stem part enclosing an outer side of the pixel electrode 191.

The line branch parts 191c of the pixel electrode 191 form an angle of approximately 40 to 45 degrees with respect to the gate line 121 or the horizontal stem part 191a. In addition, the fine branch parts 191c of two neighboring sub-regions may be orthogonal to each other. In addition, widths of the fine branch parts may become gradually wide, or intervals between the fine branch parts 191c may be different from each other.

The pixel electrode 191 includes an extension part 197 connected thereto at a lower end of the vertical stem part 191b and having an area wider than that of the vertical stem part 191b. The extension, part 197 is physically and electrically connected to the drain electrode 175 through the contact hole 185 at the extension part 197, and receives a data voltage applied from the drain electrode 175.

The above-mentioned description for the thin film transistor Q and the pixel electrode 191 is only an example, and a structure of the thin film transistor and a design of the pixel electrode may be modified to improve a side surface visibility.

A lower alignment layer 11 is formed on the pixel electrodes 191 and may be a vertical alignment layer. The lower alignment layer 11 that is a liquid crystal alignment layer made of polyamic acid, polysiloxane, polyimide, or the like, may include at least one of generally used materials. An upper alignment layer 21 is positioned at a portion facing the lower alignment layer 11, and micro cavities 305 are formed between the lower alignment layer 11 and the upper alignment layer 21.

A liquid crystal material including liquid crystal molecules 310 is injected into the micro cavities 305 having inlets 307. The micro cavities 305 may be formed in a column direction of the pixel electrodes 191, in other words, in a vertical direction. In the present exemplary embodiment, the liquid crystal material including an alignment material forming the alignment layers 11 and 21 and the liquid crystal molecules 310 may be injected into the micro cavities 305 using a capillary force.

The micro cavities 305 are divided in the vertical direction by a trench 307FP positioned at a portion overlapped with, the gate line 121, and a plurality of micro cavities 305 are formed in a direction in which the gate lines 121 are extended. Each of the plurality of micro cavities 305 may correspond to one or two or more pixel areas that may correspond to areas in which an image is displayed.

Common electrodes 270 and a lower insulating layer 350 are positioned on the upper alignment layer 21. The common electrode 270 receives a common voltage applied thereto and generates an electric field together with the pixel electrode 191 to which the data voltage is applied to determine a direction in which the liquid crystal molecules 310 contained in the micro cavity 305 between the two electrodes are inclined. The common electrode 270 forms a capacitor together with the pixel electrode 191 to maintain the applied voltage even after the thin film transistor is turned off. The lower insulting foyer 350 may be formed of a silicon nitride (SiNx) or a silicon oxide SiO2.

Although the case in which the common electrode 270 is formed above the micro cavity 305 has been described in the present exemplary embodiment, the common electrode 270 may be formed below the micro cavity 305 to drive the liquid crystal molecules 310 in a horizontal electric field mode in another exemplary embodiment.

A roof layer 360 is positioned on the lower insulating layer 350. The roof layer 360 serves to support the micro cavity 305 so that the micro cavity 305, which is a space between the pixel electrode 191 and the common electrode 270, may be formed. The roof layer 360 may include a photo-resist or other organic materials.

An upper insulating layer 370 is positioned on the roof layer 360. The upper insulating layer 370 may contact an upper surface of the roof layer 360. The upper insulting layer 370 may be formed of a silicon, nitride (SiNx) or a silicon oxide SiO2.

Referring to FIG. 3, the partition wall part PWP is formed between the micro cavities 305 neighboring to each other in the horizontal direction in which the gate lines are extended. The partition wall part PWP may be formed in a direction in which the data lines 171 are extended and may the covered by the roof layer 360. The partition wall part PWP is filled with the lower insulating layer 350, the common electrode 270, the upper insulating layer 370, and the roof layer 360. This structure may form a partition wall to partition or define the micro cavities 305.

In the present exemplary embodiment since a partition wall structure such as the partition wall part PWP is present between the micro cavities 305, even though the insulation substrate 110 is bent, less stress is generated, and a change degree of a cell cap may be significantly decreased.

In the present exemplary embodiment, a capping layer 390 fills and covers the inlets 307 of the micro cavities 305 that are exposed by the trench 307FP. That is, since the capping layer 390 contacts the liquid crystal molecules 310, the capping layer 390 may be made of a material that does not react to the liquid crystal molecules 310.

In addition, the capping layer 390 includes a material having a thickness direction phase difference Rth changed depending on an ultraviolet (UV) condition. For example, the capping layer 390 may include an organic insulating material such as parylen, silicone, an ultraviolet (UV) curable sheet, and the like.

Referring to FIG. 4, it may be appreciated that a thickness direction phase difference Rth of the material of the capping layer 390 is changed depending on an ultraviolet (UV) condition. A horizontal axis indicates an ultraviolet (UV) coating speed, and a vertical axis indicates the thickness direction phase difference Rth. The thickness direction phase difference Rth of the capping layer 390 may be adjusted to be 30nm or more to 240 nm or less depending on the material and the ultraviolet (UV) condition. The capping layer 390 of the liquid crystal display according to an exemplary embodiment of the present disclosure may have a thickness direction phase difference Rth of 120 nm or more to 140 nm or less to compensate for a phase difference Rth of a polarizer.

A lower polarizer 500 and an upper polarizer 400 are positioned on a lower surface of the substrate 110 and an upper surface of the capping layer 390, respectively. The polarizers 400 and 500 are used to polarize light transmitted through a liquid crystal layer. Transmissive axes of the lower polarizer 500 and the upper polarizer 400 may be orthogonal to each other.

Although not shown, the upper polarizer 400 may include a polyvinyl alcohol (PVA) layer positioned at the center of a laminated structure to have a polarization function having a light absorbing axis in one axial direction and first and second triacetyl cellulose (TAC) layers each positioned on both surfaces of the PVA layer.

Here, the upper polarizer 400 according to an exemplary embodiment of the present disclosure does not include the Rth compensation film.

As described above, the liquid crystal display according to an exemplary embodiment of the present disclosure includes the capping layer 390 positioned, below the upper polarizer 400 and having the thickness direction phase difference Rth of 120 nm or more to 140 nm or less, such that the Rth compensation film may not be included in the upper polarizer 400.

When external light is incident to the capping layer 390, a phase of the light polarized through the upper polarizer 400 is changed, and the light of which the phase is changed is reflected by the electrode included in the liquid crystal display. In this case, a phase different is induced in the reflected external light by the capping layer 390, such that the reflected external light is not emitted to she outside, thereby generating destructive interference. That is, when only a specific waveform (e.g., a horizontal wave) passes through the upper polarizer 400, a phase of the horizontal wave passing through the upper polarizer 400 is changed by the capping layer 390, such that the horizontal wave is reflected by the electrode included in the liquid crystal display. In this case, a vertical wave having a changed phase and reflected does not pass through the upper polarizer 400 that passes through only the horizontal wave, such that the vertical wave is extinguished.

As described above, the liquid crystal display according to an exemplary embodiment of the present disclosure includes the capping layer 390 positioned below the upper polarizer 400 and having the thickness direction phase difference Rth of 120 nm or more to 140 nm or less, and the upper polarizer 400 does not include the Rth compensation film, thereby decreasing an entire thickness of the liquid crystal display and reducing a manufacturing cost of the liquid crystal display.

The lower polarizer 500 may include a polyvinyl alcohol (PVA) layer 510 positioned at the center of a laminated structure to have a polarization function having a light absorbing axis in one axis direction, first and second triacetyl cellulose (TAC) layers (not shown) each positioned on both surfaces of the PVA layer, and an Rth compensation film 530 having a thickness direction phase difference Rth of 120 nm or more to 140 nm or less. The upper polarizer 400 may be provided on the capping layer 390 using a separate adhesive or may directly contact with and attached to the capping layer 390 without using the separate adhesive. In this case, a passivation layer (not shown) may be formed between the capping layer 390 and the upper polarizer 400. The passivation layer may include a polymer material having adhesion. The lower polarizer 500 may be attached onto a rear surface, that is, a lower surface of the substrate 110 using an adhesive, or the like.

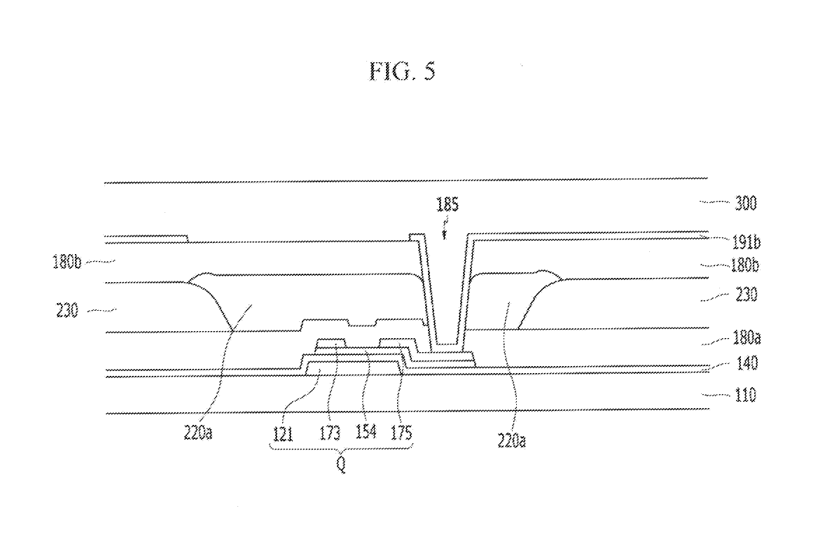

An exemplary embodiment of manufacturing the liquid crystal display described above will be described with reference to FIGS. 5 to 17. The exemplary embodiment relates to a manufacturing method and may be modified or altered without deviating from the scope of the present disclosure.

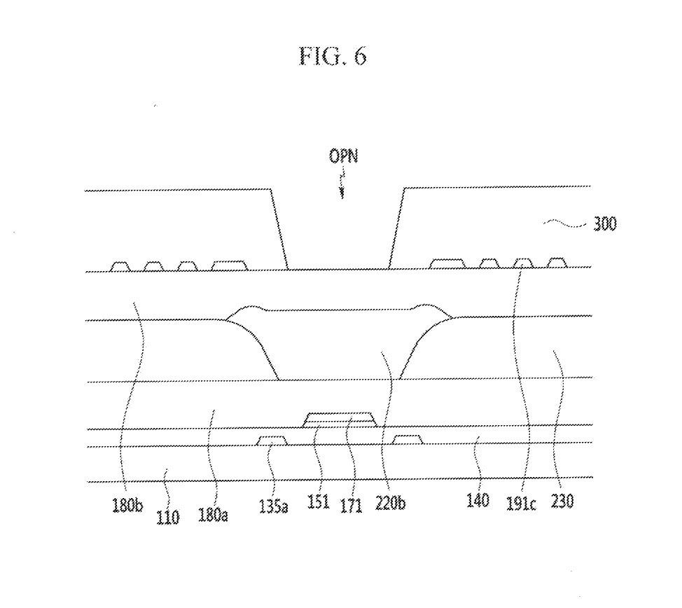

FIGS. 5, 7, 9, 11, 12, 14, 15, 16 and 17 sequentially show cross-sectional views taken, along line II-II of FIG. 1. FIGS. 6, 8, 10, 13, and 15 are cross-sectional views taken along line III-III of FIG. 1.

Referring to FIGS. 1, 5, and 6, a generally known switching element is formed on the substrate 110. The gate lines 121 extended in the horizontal direction are formed, the gate insulating layer 140 is formed on the gate lines 121, the first and second semiconductor layers 151 and 154 are formed on the gate insulating layer 140, and the source electrodes 173 and the drain electrodes 175 are formed. The data lines 171 connected to the source electrodes 173 may be formed to be extended in the vertical direction while intersecting with the gate lines 121.

The first interlayer insulating layer 180a is formed on the data conductors including the source electrode 173, the drain electrode 175, and the data line 171, and the exposed portion of the second semiconductor layer 154. The color filters 230 are formed at positions corresponding to the pixel areas on the first interlayer insulating layer 280a, and the light blocking members 220 are formed between the color filters 230. The second interlayer insulating layer 280b covering the color filters 230 and the light blocking members 220 is formed on the color filters 230 and the light blocking members 220. The second interlayer insulating layer 180b is formed to have the contact holes 185 that electrically and physically connect the pixel electrodes 291 and the drain electrodes 175 to each other.

The pixel electrodes 191 are formed on the second interlayer insulating layer 180b, and a sacrificial layer 300 is formed on the pixel electrodes 191. The sacrificial layer 300 has an open part OPN formed in a direction that is in parallel with the data lines 171, as shown in FIG. 5. The open part OPN may be filled with the common electrode 270, the lower insulating layer 350, the roof layer 360, and the upper insulating layer 370 in a subsequent process to form the partition wall parts PWP.

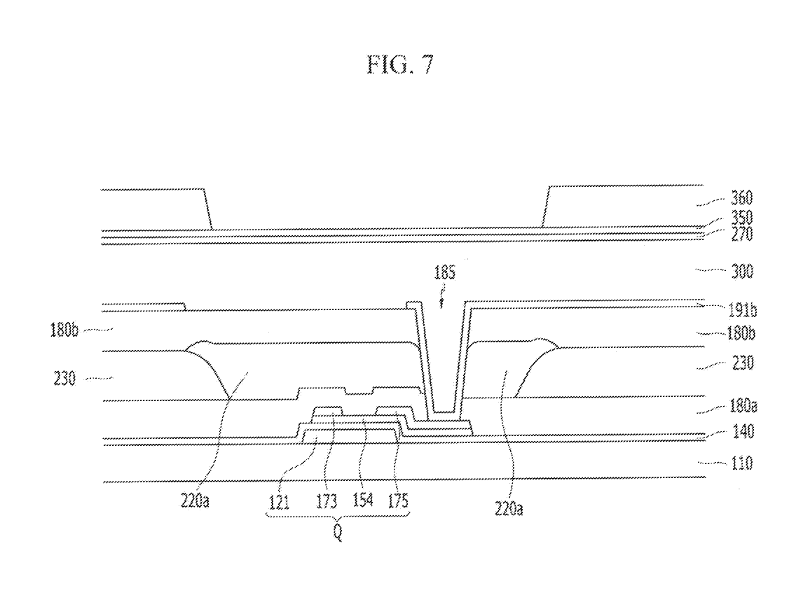

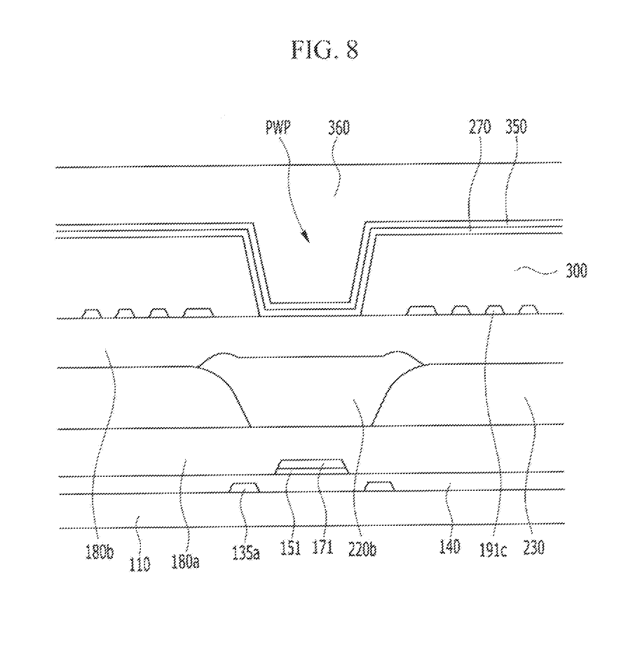

Referring to FIGS. 7 and 8, the common electrode 270, the lower insulating layer 350, and the roof layer 360 are sequentially formed on the sacrificial layer 300. The roof layer 360 may be removed in regions corresponding to the light blocking members 220 that is positioned between pixel areas neighboring to each, other in the vertical direction by an exposure and development process. The roof layer 360 exposes the lower insulating layer 350 in the regions corresponding to She light blocking members 220. The common electrode 270, the lower insulating layer 350, and the roof layer 360 form the partition wall part PWP while being filled in the open part OPN of the vertical light blocking member 220b.

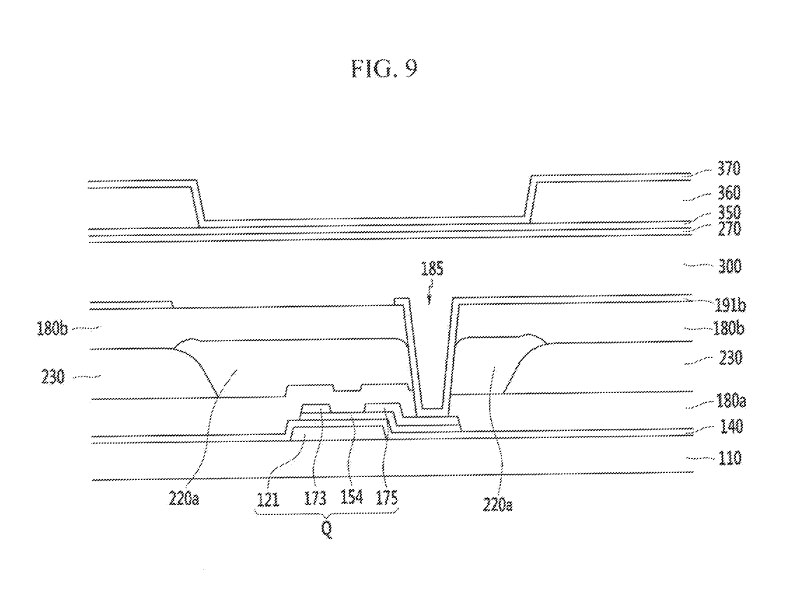

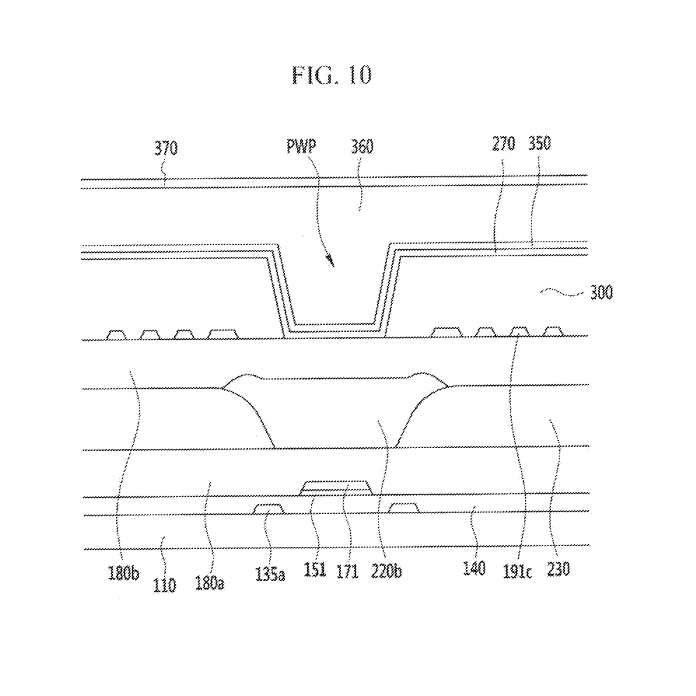

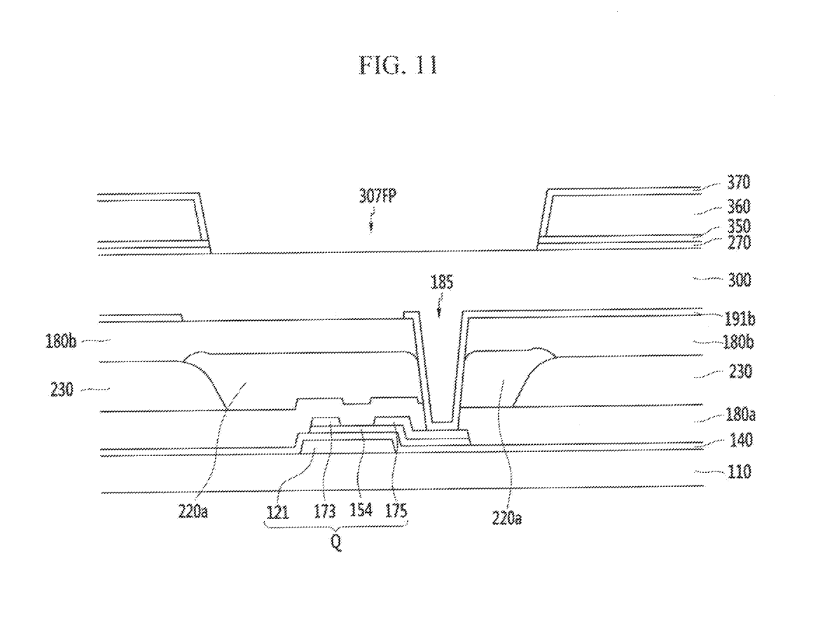

Referring to FIGS. 9 and 10, the upper insulating layer 370 is formed to cover the roof layer 360 and the exposed lower insulating layer 350. Referring to FIG. 11, the upper Insulating layer 370, the lower insulating layer 350, and the common electrode 270 are dry-etched, such that the upper insulating layer 370, the lower insulating layer 350, and the common electrode 270 are partially removed, thereby forming the trenches 307FP. Although the upper insulating layer 370 has a structure that covers a side surface of the roof layer 360, the present disclosure is not limited thereto. That is, the upper insulating layer 370 covering the side surface of the roof layer 360 may also be removed to expose the side surface of the roof layer 360.

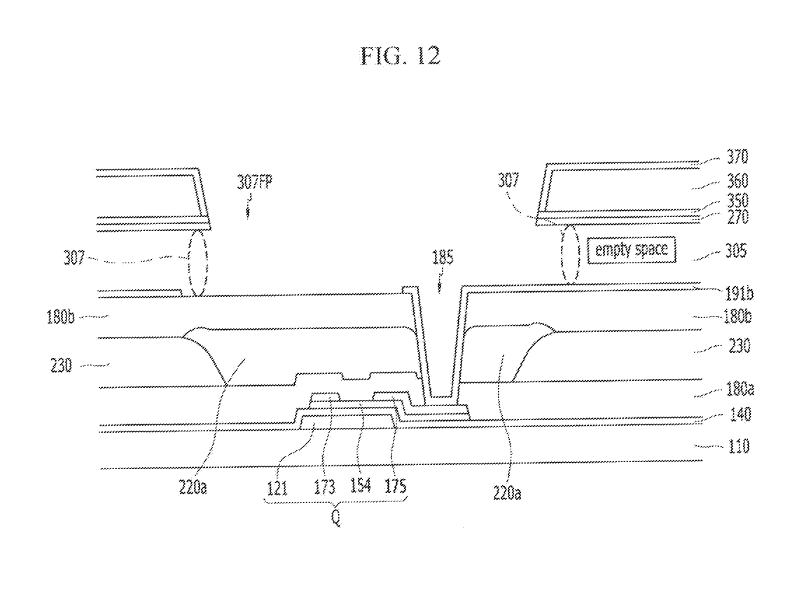

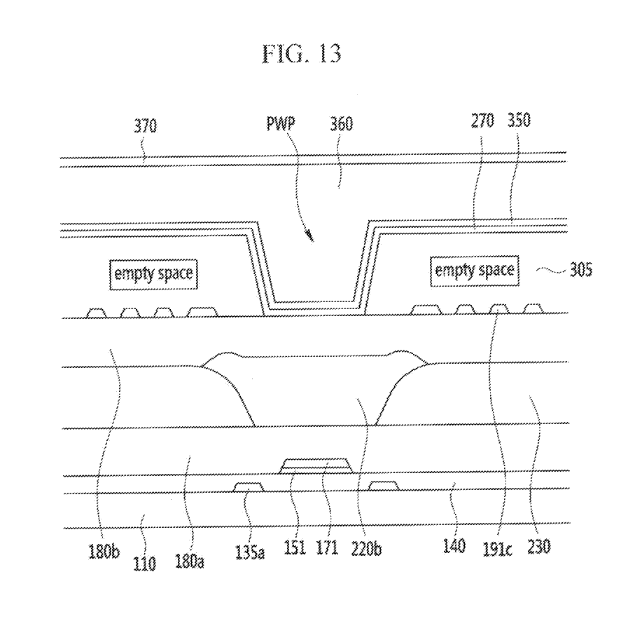

Referring to FIGS. 12 and 13, the sacrificial layer 300 is removed by oxygen (O₂) ashing, a wet etching method, or the like through the trenches 307FP. In this case, the micro cavities 305 having the inlets 307 are formed, the sacrificial layer 300 is removed, such that the micro cavities 305 are in an empty space state.

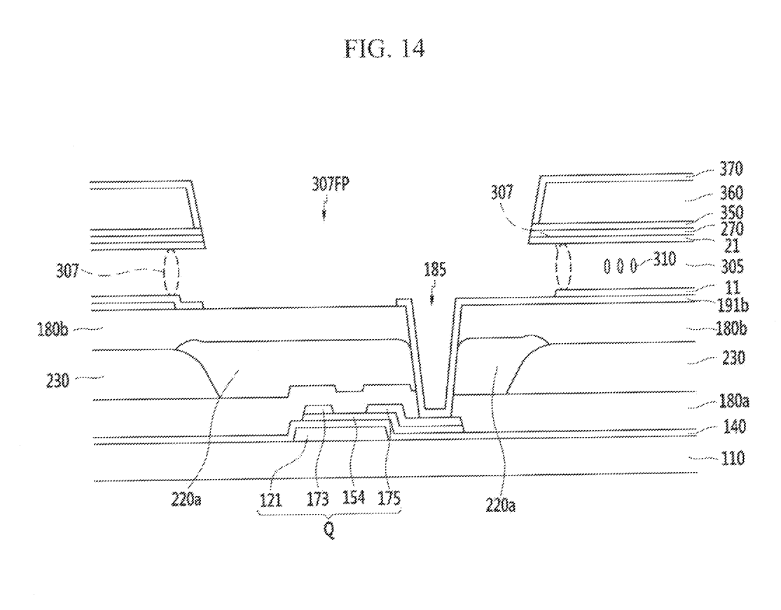

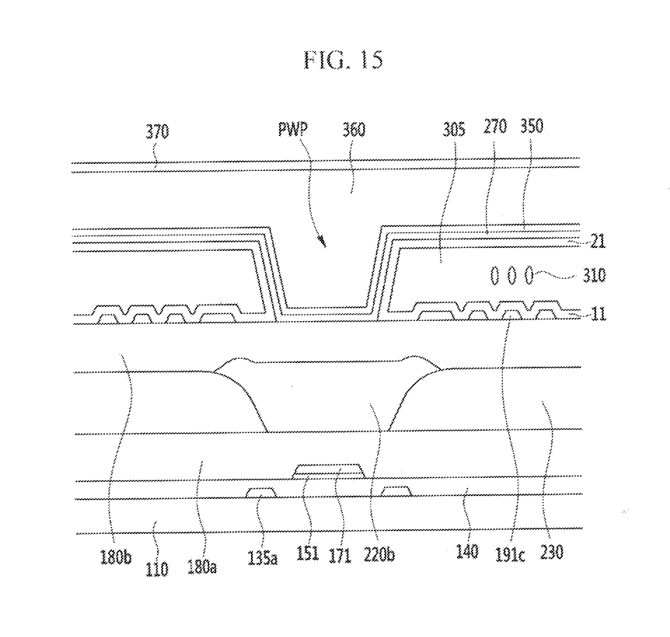

Referring to FIGS. 14 and 15, the alignment material is injected through the inlets 307 to form the alignment layers 11 and 21 on the pixel electrodes 191 and the common electrodes 270. After the alignment material including solid contents and solvents is injected through the inlets 307, a bake process is performed. Next, the liquid crystal material including the liquid crystal molecules 310 is injected into the micro cavities 303 through the inlets 307 using an inkjet method, or the like.

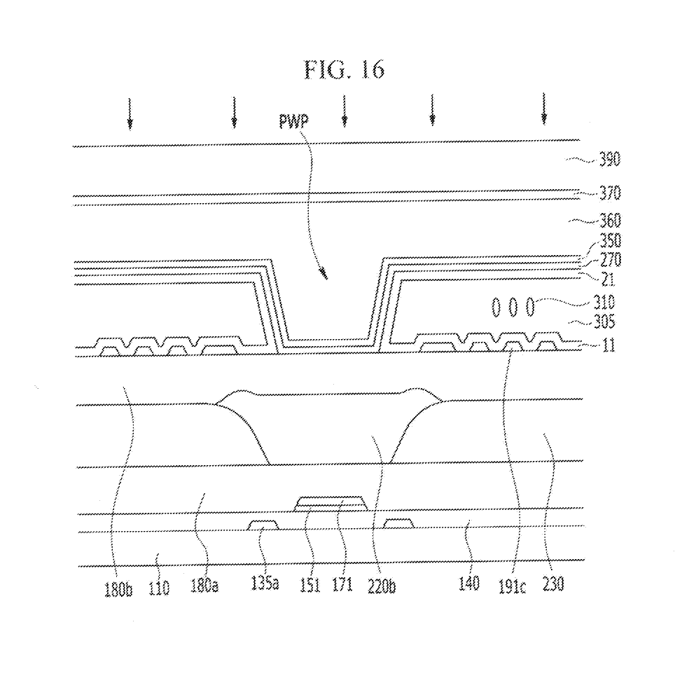

Referring to FIG. 16, the capping layer 390 is formed on the upper insulating layer 370 to cover the inlets 307. The capping layer 390 may cover the trenches 307FP. The capping layer 390 may be formed by pushing a capping material from one edge of the substrate 110 to the other edge using a bar coater and simultaneously ultraviolet-curing the capping material.

The capping layer 390 includes the material having the thickness direction phase difference Rth changed depending on the ultraviolet (UV) condition. For example, the capping layer 300 may include an organic insulating material, such as parylen, silicone, an ultraviolet (UV) curable sheet or the life. The capping layer 390 has the thickness direction phase difference Rth of 120 nm or more to 140 nm or less.

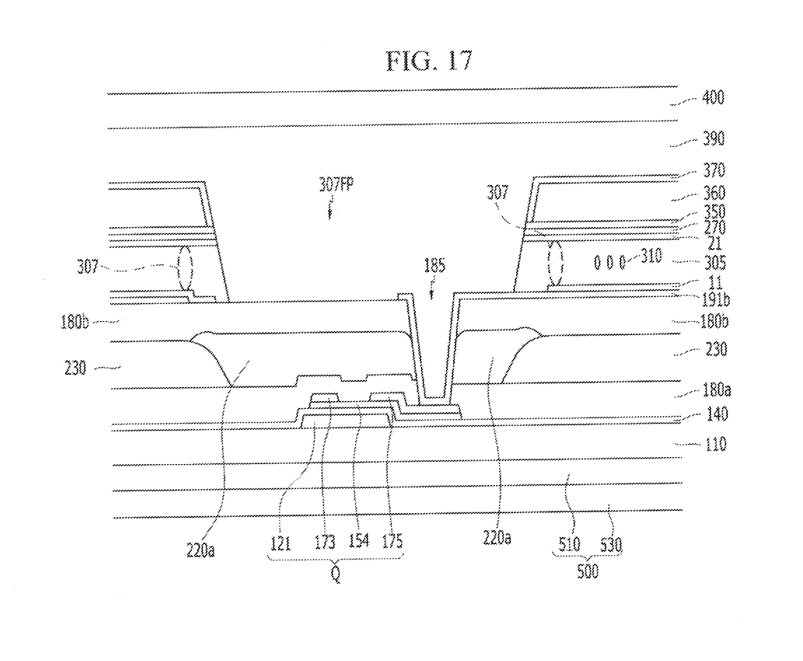

Referring to FIG. 17, the lower polarizer 500 and the upper polarizer 400 are positioned on the lower surface of the substrate 110 and the upper surface of the capping layer 390, respectively. A separate adhesive may he used to attach the upper polarizer 400 onto the upper surface of the capping layer 390 and attach the lower polarizer 500 onto the lower surface of the substrate 110. The upper polarizer 400 and the lower polarizer 500 may also directly contact and be attached to each other without using a separate adhesive. In the case, the upper polarizer 400 and the lower polarizer 500 may to include the polymer material having the adhesive.

The upper polarizer 400 may include the polyvinyl alcohol (PVA) layer (not shown) having a polarization function, that has the light absorbing axis and the first and second triacetyl cellulose (TAC) layers (not shown) each positioned on both surfaces of the PVA layer, but does not include the Rth compensation film having the thickness direction phase difference Rth of 120 nm or more to 140 nm or less. The lower polarizer 500 may include the polyvinyl alcohol (PVA) layer 510 positioned at the center of the laminated structure to have the polarization function that has the light absorbing axis in one axis direction, the first and second triacetyl cellulose (TCA) layers (not shown) each positioned on both surfaces of the PVA layer, and the Rth compensation film 530 having the thickness direction phase difference Rth of 120 nm or more to 140 nm or less. A passivation layer (not shown) may be further formed on the upper polarizer 400 to form the liquid crystal display as shown in FIG. 2.

While the present disclosure has been described in connection with what is presently considered to he practical exemplary embodiments, it is to be understood that the present disclosure is not limited to the disclosed embodiments, but on the contrary, is intended to cover various modifications and equivalent arrangements included within the spirit and scope of the appended claims.

<Description of Symbols>

300: sacrificial layer

305: microavity

307: inlet

350: lower insulating layer

360: roof layer

370: upper insulating layer

390: capping layer

400: upper polarizer

500: lower polarizer

What is claimed is:

1. A liquid crystal display comprising:
a substrate;
a thin film transistor positioned on the substrate;
a pixel electrode positioned on the thin film transistor;
a roof layer facing the pixel electrode;
a liquid crystal layer positioned between the pixel electrode and the roof layer and including a plurality of micro cavities filled with a liquid crystal material,
a capping layer positioned on the root layer and having a thickness direction phase difference Rth of 120 nm or more to 140 nm or less; and
an upper polarizer positioned on the capping layer and a lower polarizer positioned below the substrate.

2. The liquid crystal display of claim 1, wherein:
the capping layer includes a material having a thickness direction phase difference Rth changed depending on an ultraviolet (UV) curing condition.

3. The liquid crystal display of claim 2, wherein:
the capping layer includes at least one of an organic insulating material including parylen, silicone, and an ultraviolet (UV) curable sheet.

4. The liquid crystal display of claim 1, wherein:
the upper polarizer includes a polyvinyl alcohol (PVA) layer.

5. The liquid crystal display of claim 4, wherein:
the upper polarizer excludes an Rth compensation film.

6. The liquid crystal display of claim 5, wherein:
a thickness direction phase difference Rth of the Rth compensation film is 120 nm or more to 140 nm or less.

7. The liquid crystal display of claim 1, wherein:
the lower polarizer includes a polyvinyl alcohol (PVA) layer and an Rth compensation film positioned below the substrate.

8. The liquid crystal display of claim 7, wherein:
a thickness direction phase difference Rth of the Rth compensation film is 120 nm or more to 140 nm or less.

9. The liquid crystal display of claim 1, further comprising:
a common electrode and a lower insulating layer positioned between each of the plurality of micro cavities and the roof layer,
wherein the lower insulating layer is positioned on the common electrode.

10. The liquid crystal display of claim 9, wherein:
the plurality of micro cavities include a plurality of regions corresponding to pixel areas, trenches are positioned between plurality of regions, and the capping layer covers the trenches.

11. The liquid crystal display of claim 10, wherein:
the trenches are extended in a direction that is in parallel with gate lines connected to the thin film transistor.

12. The liquid crystal display of claim 21, wherein:
the thin film transistor is connected to data lines, and partition wall parts are formed, between the plurality at micro cavities in a direction in which the data lines are extended.

13. A method of manufacturing a liquid crystal display, comprising:
forming a thin film transistor on a substrate;
forming a pixel electrode that is connected to one terminal of the thin film transistor:
forming a sacrificial layer on the pixel electrode;
forming a roof layer on the sacrificial layer;
forming a plurality of micro cavities;
forming inlets by removing the sacrificial layer;
injecting a liquid crystal material into the plurality of micro cavities;
forming a capping layer on the roof layer, the capping layer covering the inlets and having a thickness direction phase difference Rth of 120 nm or more to 140 nm or less by UV curing; and
forming an upper polarizer on the capping layer and forming a lower polarizer below the substrate.

14. The method of manufacturing a liquid crystal display of claim 13, wherein:
the capping layer includes a material having a thickness direction phase difference Rth changed depending on an ultraviolet (UV) curing condition.

15. The method of manufacturing a liquid crystal display of claim 14, wherein:
the capping layer Includes at least one of an organic insulating material including parylen, silicone, and an ultraviolet (UV) curable sheet.

16. The method of manufacturing a liquid crystal display of claim 13, wherein:
the upper polarizer excludes an Rth compensation film.

17. The method of manufacturing a liquid crystal display of claim 13, wherein:
the lower polarizer is positioned below the substrate.

18. The method of manufacturing a liquid crystal display of claim 17, wherein:
the lower polarizer includes a polyvinyl alcohol (PVA) layer and an Rth compensation film positioned below the substrate.
